(19) United States
(12) Patent Application Publication
(10) Pub. No.: US 2019/0126403 A1
(43) Pub. Date: May 2, 2019

(54) METHOD FOR SETTING UP A ROTARY PROCESSING MACHINE AND ROTARY PROCESSING MACHINE

(71) Applicant: J.G. Weisser Söhne GmbH & Co. KG, St. Georgen (DE)

(72) Inventor: Thorsten Rettich, Konigsfeld (DE)

(73) Assignee: J.G. Weisser Söhne GmbH & Co. KG, St. Georgen (DE)

(21) Appl. No.: 16/091,254

(22) PCT Filed: Jan. 27, 2017
(86) PCT No.: PCT/EP2017/000101

§ 371 Date: Oct. 4, 2018

(30) Foreign Application Priority Data
Apr. 16, 2016 (DE) 10 2016 004 657.0

(51) Int. Cl. B23K 26/34; B23K 26/354; B23B 31/10

(52) U.S. Cl. CPC B23K 26/34; B23K 2101/34; B23B 31/10; B23K 26/354

(57) ABSTRACT

A method for setting up a rotary processing machine (1), in which at least one base jaw (4) of a workpiece receptacle is set up to receive a workpiece type that is to be processed and in which the base jaw (4) is coated on a workpiece contact surface (15).

### BACKGROUND

The invention describes a method for setting up a rotary processing machine, wherein a base jaw of a workpiece receptacle is set up to receive a workpiece type that is to be processed, as well as a rotary processing machine with workpiece receptacle, which comprises at least one base jaw, in particular for executing the method according to the invention.

Such rotary processing machines are known for the processing of workpieces. In this case, the workpiece is firmly clamped in a workpiece receptacle, which is rotatable with respect to a substantially fixed tool. There are various clamping devices for firmly clamping the workpiece in the workpiece receptacle, which can be selected according to shape and condition of the workpiece.

A frequently used form of such workpiece receptacles are round rotary chucks with receptacles for clamping jaws, which can be fastened in different radial positions in order to clamp a workpiece. Usually these clamping jaws have latching elements, which cooperate with corresponding latching elements of the rotary chuck in order to fix the radial position of the clamping jaws inside the rotary chuck.

In order to ensure the strength of the latching elements, the latching cannot be configured to be arbitrarily precise. Consequently it is clear that not any workpiece fits to one of the specified latching positions and can be firmly clamped in. In this case, a gap remains between clamping jaw and workpiece. In order to fill such gaps, there are underlays, for example so-called parallel underlays, in various thicknesses, which can be inserted between workpiece and clamping jaw.

However, even with these measures a precise adjustment and clamping of the workpiece is sometimes difficult and time-consuming.

In order to ensure a precise clamping, there are rotary chucks, in which the clamping jaws can be adjusted radially by fine threads so that the insertion of underlays can be dispensed with. However, this type of setting up of the workpiece is also time-consuming.

Finally, the clamping jaws can be matched to the tool to be clamped. Either by machining of universal base jaws or by specific manufacture of suitable clamping jaws. For example, by injection molding, sintering, or other shaping. To this end however, an additional processing step is required, which is also expensive and time-consuming.

All of these three methods for setting up have in common that they necessarily include manual process steps and therefore cannot be automated or only with difficulty. The setting up of the rotary processing machine is accordingly expensive, time-consuming, and prone to error.

### SUMMARY

It is therefore the object of the invention to provide a method for setting up a rotary processing machine, which can be automated and therefore can be carried out substantially more efficiently, cost-effectively, and more rapidly.

This object is achieved by the method according to the invention with the features specified in the main claim.

According to the invention, a base jaw is coated on a workpiece contact surface. The dimensions of the base jaw can be adapted more precisely to the workpiece with the aid of the coating. A manual adjustment of the base jaws or providing the workpiece with underlays is therefore no longer required. A manual adaptation of the workpiece receptacle to the workpiece is therefore no longer required.

This coating can take place in a separate coating device. It is particularly expedient however if the coating takes place in situ, i.e. on the installed base jaw. The base jaw or jaws are already located in the workpiece receptacle for and during the coating. As a result of the coating, the base jaws acquire a shape which matches the workpiece. Consequently, no additional process step is required after the coating. The setting up of the workpiece receptacle and the rotary processing machine can thus be easily automated and therefore can be executed substantially more simply and cost-effectively.

It is particularly advantageous if the coating takes place in the rotary machine. This means on the workpiece receptacle already installed in the rotary machine.

The coating of the base jaws can be accomplished in various ways, for example, by a known coating method. In an expedient embodiment of the invention, the coating is accomplished by friction of a consumable material on a surface to be coated, in particular on a workpiece contact surface. In this case, the consumable material can, for example, be of metal, plastic, or a composite material. Particularly preferably the consumable material is formed of steel, a non-ferrous metal and/or plastic.

The friction includes a relative movement between consumable material and base jaw while the consumable material is pressed with a defined pressure onto the base jaw.

The relative movement can be accomplished, for example, by turning, vibrating, or rotational vibrating. Wherein either the consumable material and/or the base jaw is moved, for example, by an electric motor.

In an alternative embodiment of the invention, the coating is accomplished for example by laser sintering. In this case, a sinterable powder is applied to the base jaw, which is then sintered by heat input of the laser. Here also the powder can, for example, be formed of metal, plastic, or another material. Powder mixtures of various materials can also be used to obtain a composite material. Through repeated application and sintering, even large layer thicknesses can thus be achieved which have the same mechanical material properties throughout.

The coating can alternatively or alternately also be accomplished by an electric arc. Known methods for this for example are electric arc vapor deposition or electric arc spraying.

In principle, it is possible to combine several of these coating methods in order for example to apply different layers at different points of the base jaws and/or in order to apply different layers above one another. In this case, the layers can also consist of different materials.

The coating is used in particular to match the base jaws to a workpiece. In addition, the coating can also fulfil further functions. The coating can, for example, serve to reduce corrosion and/or wear.

It is particularly expedient if an adhesive-friction enhancing coating is applied by the coating. As a result, not only the geometry of the base jaws is adapted to the workpiece but also the adhesion of the workpiece on the base jaw is enhanced. The torque which can be applied to the workpiece increases as a result so that subsequently during the actual rotary machining, a tool can act on the workpiece with greater force, with the result that the removal rate and therefore the processing rate is increased and the fabrication time is reduced.

The layer thickness or the application thickness of the coating of the base jaw cannot be controlled or adjusted exactly depending on the coating method. Depending on the required tolerance, it can be necessary or appropriate to rework the base jaw after coating in order to obtain a precise surface.

This reworking can include any machining or other processing steps. The coating of the base jaws can, for example, be milled, ground, or turned.

The reworking can take place in a separate machine in a separate process. In an advantageous embodiment of the invention, the base jaw can be machined after the coating on the coated workpiece contact surface using a tool arranged in a working position of the rotary processing machine. As a result, a very precise matching to a contour of the workpiece type is achieved. The advantage consists in that the processing is accomplished in the rotary processing machine using a conventional turning tool, which can also be used for processing a workpiece. The rotary processing machine in this case processes itself so that virtually no manual working steps are required. This means that the coating and the reworking of the coating take place in situ, i.e. in the rotary processing machine. The setting up of the rotary processing machine can take place substantially fully automatically. The method according to the invention is as a result substantially faster and more cost-effective and therefore more efficient.

The object according to the invention is also achieved by a rotary processing machine of the aforesaid type, which has a coating device by which the base jaw can be coated on a workpiece contact surface. Consequently, the method according to the invention can be carried out and the associated advantages achieved.

It is particularly advantageous if the coating device is configured in such a manner that the base jaw can be coated in its usage position. The base jaws can then remain in the usage position and be used directly after the coating. As a result, a manual setting up can be dispensed with.

Expediently the coating device is arranged movably in the rotary processing machine so that it can be moved between a coating position in which the base jaw can be coated in its usage position and a rest position.

The coating device can be mounted, for example pivotably or displaceably.

The coating device can have different configurations for different coating methods.

In an advantageous embodiment of the invention, the coating device has an application unit by which a consumable material can rubbed on the workpiece contact surface. Thus, a base jaw can be coated as described above by rubbing.

In an alternative embodiment of the invention, the coating device is adapted for a laser sintering or for coating by electric arcs.

Preferably this coating device has a device for applying a sinterable powder and a laser source for generating a laser beam to heat the applied powder.

For the further reworking of a coated base jaw, it is expedient if a tool can be clamped in a tool receptacle, by which the workpiece contact surface of the base jaw can be turned. As a result, a reworking of the coated base jaw can take place in the rotary processing machine itself. The base jaw can thus be processed overall completely in the rotary processing machine and adapted to a workpiece. The setting up of the rotary processing machine can thus take place automatically and is therefore cost-effective and efficient.

### BRIEF DESCRIPTION OF THE DRAWINGS

The method according to the invention and an advantageous embodiment of a rotary processing machine according to the invention are explained in detail hereinafter with reference to the appended drawings.

In the figures:

FIG. 1 shows a schematic diagram of a rotary processing machine according to the invention,

FIG. 2 shows a detailed view of the coating device during the coating process,

FIG. 3 shows a detailed view of the coating device after the coating process, and

FIG. 4 shows a detailed view of the tool receptacle during the processing of the base jaw.

### DETAILED DESCRIPTION

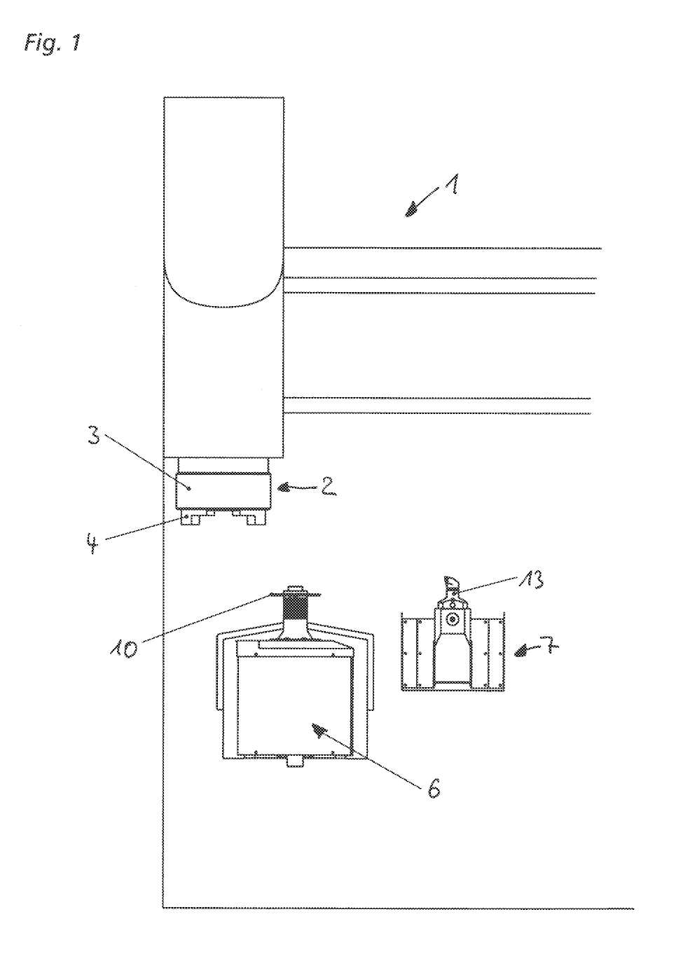

FIG. 1 shows a rotary processing machine according to the invention, designated overall with 1, hereinafter called for simplicity rotary machine. The rotary machine 1 has a workpiece receptacle 2, which is configured in the example as a so-called triple-jaw rotary chuck 3. Three base jaws 4 are arranged on the rotary chuck 3 aligned radially to one another with an angular spacing of 120°, wherein only two of the base jaws 4 are shown in the diagram for better clarity.

The base jaws 4 have a substantially cuboid shape which is extended in the radial direction and have an axial step 5. The base jaws 4 can be aligned in the radial direction in the rotary chuck 3 in order to clamp in a workpiece. Such base jaws 4 are standard parts for rotary machines 1 and exist in various forms and embodiments. Thus, there are also base jaws 4 with none, two or more axial steps 5. Likewise there are rotary chucks 2 with more than three base jaws 4.

Furthermore, the rotary machine 1 has a coating device 6 for the in situ coating of the base jaws 4 and/or the workpiece receptacle 2 and/or a processing device 7 for the machining of the base jaws 4 and/or the workpiece receptacle 2.

Both the coating device 6 and also the processing device 7 are arranged movably in the rotary machine 1 so that they can be positioned in a working position for coating or processing the rotary chuck 3. The type of movement does not play any significant part for the invention and is therefore not shown in detail here. The rotary machine 1 can, for example, comprise a rotary plate or turret, on which the coating device 6 and the processing device 7 are arranged so that these can be brought into the corresponding working position by a rotation of the rotary plate.

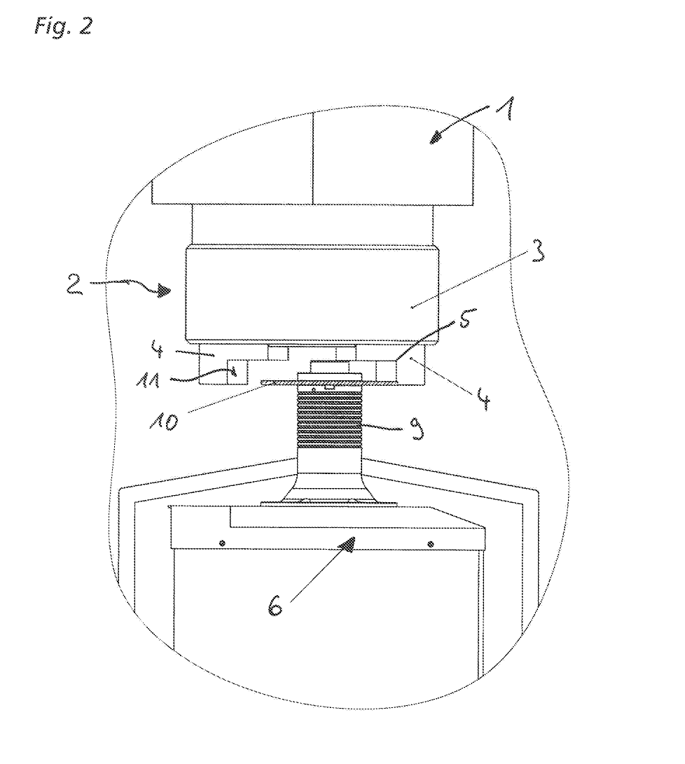

A coating device 5 is shown in detail in FIG. 2. In the example this is configured for the coating by friction of a consumable material on an object to be coated, wherein the friction is produced by rotation of one of these friction partners.

The coating device 6 has an application unit 8, which contains a substantially rod-shaped holder 9, on which a circular disk made of a consumable material 10 can be fastened in a torque-proof manner.

Since the rotary chuck 3 is already configured for rotation of a workpiece, the rotary chuck 3 is also driven for the coating process. The consumable material 10 is therefore fixed.

Alternatively however, the coating device 6 can also be configured so that for example the consumable material 10 or the holder 9 are rotatably drivable. In this case, the rotary chuck 3 can be fixed.

The coating device 6 or the rotary machine 1 additionally have means in order to move the consumable material 10 linearly in several spatial axes with respect to the surface 11 to be coated so that the consumable material 10 can be pressed onto the surface 11 to be coated.

Instead of or in addition to the friction coating device shown here, a laser sintering device can be provided. Such a laser coating device can comprise an application unit, by which a sinterable powder can be applied to a surface to be coated. Furthermore, a laser can be provided which brings about a sintering process by heat input into the sinterable powder.

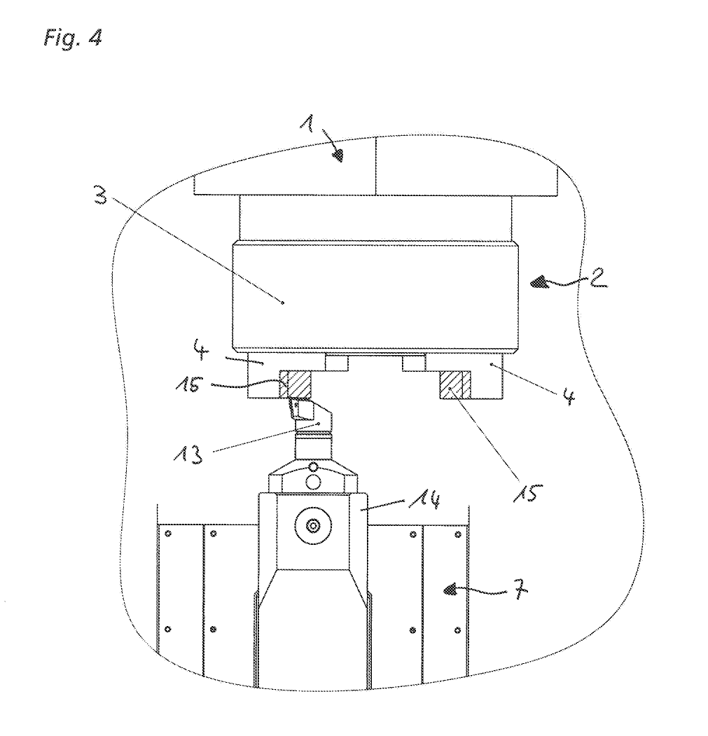

A processing device 7 is shown more accurately in FIG. 4. This has a tool receptacle 12, in which a tool 13 for turning can be inserted. The processing device 7 or the rotary machine 1 additionally have a device for moving the tool 13 in several spatial axes linearly with respect to the surface 11 to be processed.

The setting up of a rotary machine 1 can now be accomplished with the following process steps, in principle fully automatically.

Firstly a rotary chuck 3, possibly a triple-jaw chuck is fitted with standard base jaws 4, as shown in FIG. 1.

The coating device 6 arranged in the rotary machine 1 is then moved into the working position for coating (FIG. 2). The main spindle of the rotary machine 1 is driven and thus the rotary chuck 3 is set in rotation. The application unit 8 is moved linearly so that the disk 10 of consumable material is pressed against the surfaces 11 to be coated of the base jaws 4. Due to the movement of the base jaws 4 with the rotary chuck 3 and the contact pressure of the consumable material 10 on the surface 11, friction is produced between consumable material and surface 11. This friction brings about a removal of the consumable material 10 from the disk and a deposition of the consumable material 10 as coating 14 on the surface 11.

In this way, various coatings 14 can be produced, if necessary also with several layers of different materials.

Due to the coating 14, for example, the dimensions or the geometry of the base jaws 4 can be adapted to a workpiece to be processed or a workpiece type if many workpieces of the same type are processed. Advantageous for example is a coating 14 on the workpiece contact surfaces 15 of the base jaws 4, which abut against the workpiece.

In addition to the adaptation of the geometry, this coating 14 can, for example, also be a hard layer for reducing the wear or an adhesion-promoting layer for more secure holding of a workpiece.

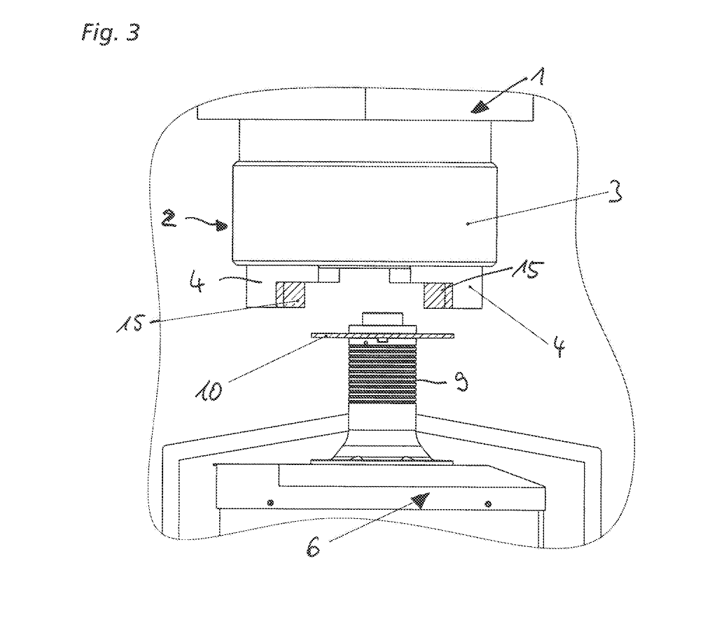

After the coating of the base jaws 4, the coating device 6 is again moved out of the working position (FIG. 3).

These base jaws 4 thus coated now have the suitable dimensions and properties and can be used directly for receiving a workpiece. A further setting up or adaptation of the rotary machine is not required.

The rotary machine 1 according to the invention can set itself up according to this method according to the invention, which can be executed very simply and efficiently.

The geometry of the base jaws 4 can alternatively also be accomplished by a machining inside the rotary machine 1 (FIG. 4). Here also the rotary machine 1 is initially fitted with a rotary chuck 3 with standard base jaws 4.

A tool 13 is inserted into the tool receptacle 12 of a processing device 7 and the tool 13 is moved into a working position with respect to the workpiece receptacle 2. The tool can, for example, be an arbitrary turning tool.

The spindle of the rotary machine 1 is driven, with the result that the rotary chuck 3 is set in rotation. With the aid of the tool 13 of the processing device 7, material is now cut from the base jaws 4. In this way, it is possible to precisely adapt the geometry of the base jaws 4 to a workpiece.

After the processing, the processing device 7 can be moved from the working position and the rotary chuck 3 can be used immediately to receive a workpiece. Here also the adaptation and processing of the base jaws 4 takes place in situ so that no further or additional setting up of the rotary machine 1 is necessary.

Naturally these two methods can also be arbitrarily combined with one another.

It is particularly advantageous if firstly the base jaws 4 are coated by the coating device 6 and then the coated surfaces, in particular the workpiece contact surfaces 15, are re-machined by the processing device 7.

However, it is also feasible that the base jaws 4 are initially machined and then coated.

The method can, for example, also be used to achieve a fully automatic self-setting up of the rotary machine 1 for workpieces which differ slightly from one another. Thus, for example the workpiece receptacle 2 can be adapted to a workpiece by coating and possibly subsequent reworking of the base jaws 4.

After the turning of the workpiece, the coating 12 can firstly be removed from the base jaws 4 by the processing device 7 in order to then apply a new coating 12 for a further different workpiece, with possibly subsequent reworking. This process can then be repeated almost arbitrarily.

The invention describes a method for setting up a rotary processing machine in which at least one base jaw of a workpiece receptacle is adapted for receiving a workpiece type to be processed and the base jaw is coated on a workpiece contact surface.

### REFERENCE LIST

1 Rotary machine
2 Workpiece receptacle
3 Rotary chuck
4 Base jaw
5 Axial step on base jaw
6 Coating device
7 Processing device
8 Application unit
9 Holder
10 Disk of consumable material
11 Surface to be coated
12 Tool receptacle
13 Tool
14 Coating
15 Workpiece contact surfaces

1. A method for setting up a rotary processing machine (1), the method comprising:
setting up a base jaw (4) of a workpiece receptacle (2) to receive a workpiece type that is to be processed by coating the base jaw (4) on a workpiece contact surface (11).

2. The method as claimed in claim 1, the coating is executed on the base jaw (4) in an installed position on the rotary processing machine.

3. The method as claimed in claim 1, further comprising after the coating, machining the base jaw (4) using a tool (13) arranged in a working position of the rotary processing machine (1) on the coated workpiece contact surface (15).

4. The method as claimed in claim 1, wherein the coating is accomplished by friction of a consumable material (10) on the workpiece contact surface (15).

5. The method as claimed in claim 4, wherein at least one of steel, non-ferrous metal, or plastic is used as the consumable material.

6. The method as claimed in claim 1, wherein the coating is accomplished by at least one of laser sintering or by electric arcs.

7. The method as claimed in claim 1, further comprising applying an adhesive-friction enhancing coating via the coating.

8. A rotary processing machine (1) comprising:
a workpiece receptacle (2), which has at least one base jaw (4); and a coating device (6) by which the base jaw (4) is adapted to be coated on a workpiece contact surface (15).

9. The rotary processing machine (1) as claimed in claim 8, further comprising a tool (13) clamped in a tool receptacle (12), by which the workpiece contact surface (15) of the base jaw (4) is machined.

10. The rotary processing machine as claimed in claim 8, wherein the coating device (6) comprises an application unit (8) by which a consumable material (10) is adapted to be rubbed against the workpiece contact surface (10).

11. The rotary processing machine as claimed in claim 8, wherein the coating device (6) is configured for laser sintering.

12. The method as claimed in claim 3, wherein the machining includes at least one of turning, grinding, or milling.
